(19) United States
(12) Patent Application Publication
(10) Pub. No.: US 2005/0223317 A1
(43) Pub. Date: Oct. 6, 2005

(54) Content management system

(76) Inventors: Loralie A. Byrer, Auburn, WA (US); Jon W. Brueske, Auburn, WA (US); Jeffrey A. Ray, Seattle, WA (US)

Correspondence Address: ROBERT R. RICHARDSON, P.S., P. O. BOX 2677, SILVERDALE, WA, 98383-2677, US

(21) Appl. No.: 10/936,312

(22) Filed: Sep. 8, 2004

Related U.S. Application Data
(60) Provisional application No. 60/558,376, filed on Mar. 31, 2004.

(51) Int. Cl. G06F 17/24

(52) U.S. Cl. 715/513; 715/530

(57) ABSTRACT

Exemplary systems and methods for managing content of documents are provided. Only the sections of a document that have been revised or added are processed. An original document is retrieved and content is revised or added as desired. The revised or added content may be stored. When it is desired to process the revised or added content, the revised or added content is retrieved. XML files that describe the revised or added content are created, and the revised or added content is processed. For example, the processing may include translating the content. After the revised or added content is processed, XML files that describe the processed revised or added content are parsed and the processed revised or added content is stored. When desired, the processed revised or added content is retrieved and a revised document that includes the revised or added content is generated.

### CROSS-REFERENCE TO RELATED APPLICATIONS

This Application is a Non-Prov of Prov (35 USC 119(e)) application 60/558,376 filed on Mar. 31, 2004, the contents of which are hereby incorporated by reference.

### FIELD OF THE INVENTION

This invention relates generally to information processing and, more specifically, to document processing and translation.

### BACKGROUND OF THE INVENTION

Manufacturers and service organizations create documents that explain their products or deliver their services to their customers. For example, such documents may include users manuals, maintenance manuals, or computer program media or Web pages that provide an interface to the user for the service.

Naturally, such documents are created in the native language of the organization. However, in a global economy, organizations may have customers in several different countries where the native language is different from that of the organization. As a result, these documents are often translated into several languages.

As a product or service evolves, documentation for that product or service is revised. For example, errors may be corrected; additional text may be added to explain new product features or services that are offered; or graphics may be replaced or revised as desired. Again, the revisions to the documentation are made in the native language of the organization. However, the revised documents must be provided to the organization's customers in the native language of the customer.

One approach to providing the revised document to the customer in the appropriate language would be to revise a document in the language of the organization; provide the revised document to a translation organization; and then forward the revised, translated document to the customer in the customer's native language. However, such an approach entails translating text that has not been revised. As a result, this approach invokes unnecessary time, labor, and expense.

Therefore, there is an unmet need in the art for a system and method for processing only the sections of a document that have been revised and forwarding to a customer the entire revised document in the customer's language.

### SUMMARY OF THE INVENTION

Embodiments of the present invention provide a system and a method for managing content of documents. According to the present invention, only the sections of a document that have been revised or added are processed. As a result, documents can be managed with less time and lower expenses compared with conventional methods that process the entire contents of a document—regardless of whether or not the contents have been revised or added.

According to an exemplary embodiment of the present invention, an original document is retrieved and content is revised or added as desired. The revised or added content may be stored. When it is desired to process the revised or added content, the revised or added content is retrieved. Markup language files that describe the revised or added content are created, and the revised or added content is processed. For example, the processing may include translating the content. After the revised or added content is processed, markup language files that describe the processed revised or added content are parsed and the processed revised or added content is stored. When desired, the processed revised or added content is retrieved and a revised document that includes the revised or added content is generated.

According to an aspect of the present invention, the documents may include Web pages. However, any document may be processed as desired.

According to another aspect of the present invention, the markup language files may be XML files. However, HTML or SGML files may be created if desired.

### BRIEF DESCRIPTION OF THE DRAWINGS

FIG. 1A and 1B are exemplary original documents in English and French, respectively;

FIGS. 2A and B are exemplary revised documents in English and French, respectively;

FIGS. 3A and 3B are flow charts of an exemplary method according to an embodiment of the present invention; and

FIG. 4 is a block diagram of an exemplary system according to an embodiment of the present invention.

### DETAILED DESCRIPTION OF THE INVENTION

Embodiments of the present invention provide a system and a method for managing content of documents. According to the present invention, only the sections of a document that have been revised or added are processed. As a result, documents can be managed with less time and lower expenses compared with conventional methods that process the entire contents of a document—regardless of whether or not the contents have been revised or added.

Given by way of overview and according to an exemplary embodiment of the present invention, an original document is retrieved and content is revised or added as desired. The revised or added content may be stored. When it is desired to process the revised or added content, the revised or added content is retrieved. XML files are created, and the revised or added content is processed. For example, the processing may include translating the content. After the revised or added content is processed, the XML files are parsed and the processed revised or added content is stored. When desired, the processed revised or added content is retrieved and a revised document that includes the revised or added content is generated. Details of exemplary embodiments will now be discussed.

First, an explanation will be given by way of non-limiting example of exemplary documents that include data that may be processed by embodiments of the present invention. Next, an exemplary method according to the present invention will be explained. Finally, an exemplary system according to the present invention will be explained.

Exemplary Documents

Exemplary documents that include data that may be processed according to embodiments of the present invention will now be explained. The exemplary documents that are given by way of non-limiting example are illustrated as Web pages. However, it will be appreciated that any type of document may include data that may be processed by embodiments of the present invention. As such, it is not intended that the present invention be limited to processing data that is included in Web pages.

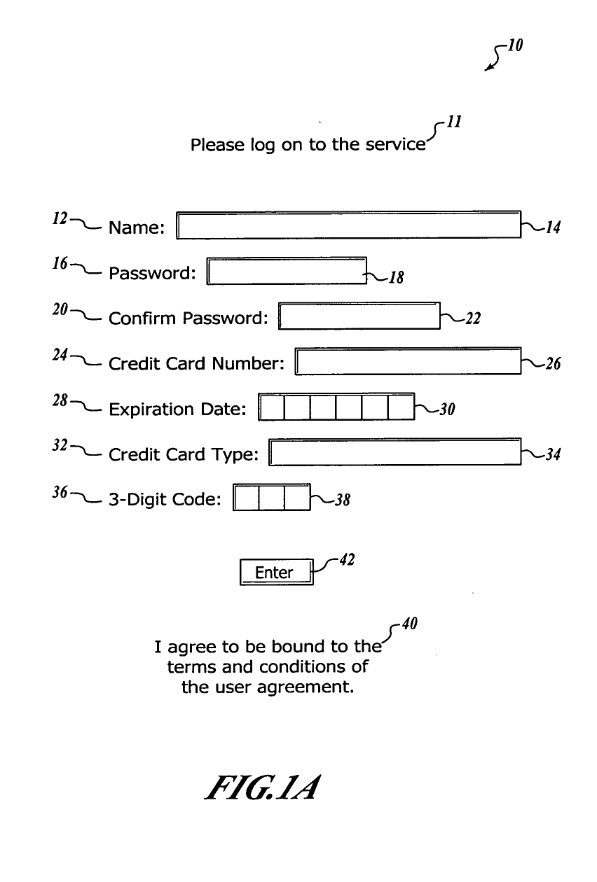

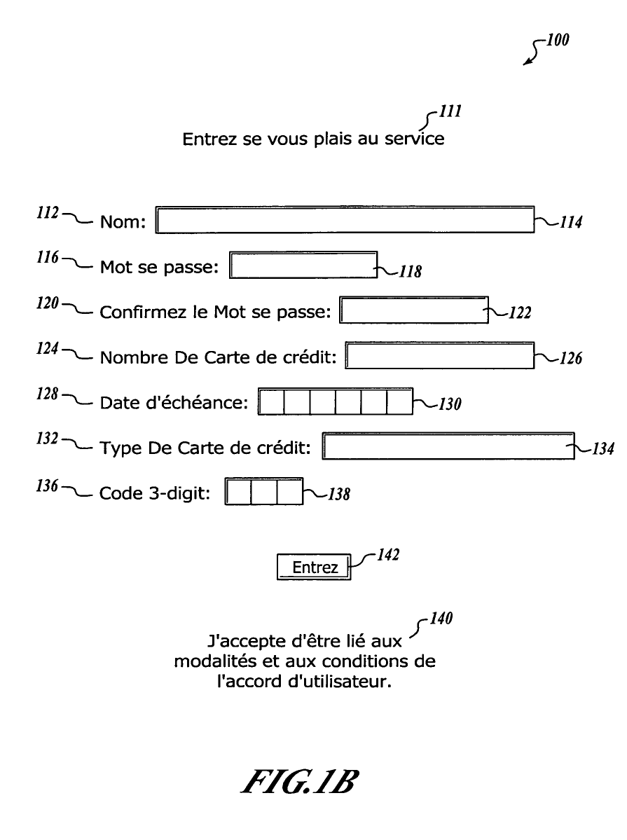

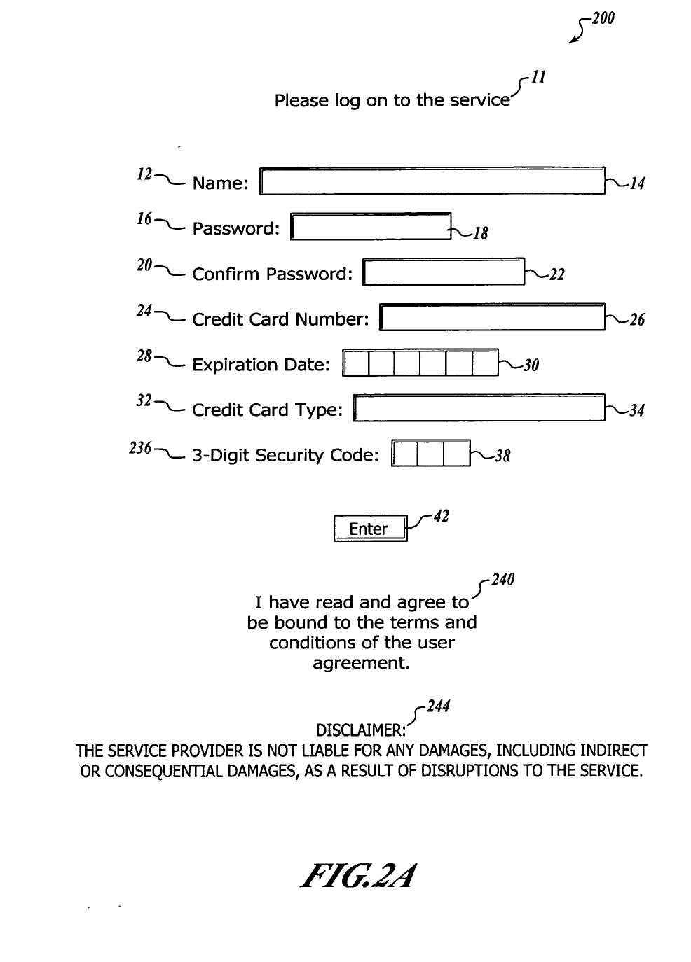

Referring now to FIG. 1A, an exemplary document that includes data that may be processed by embodiments of the present invention is shown by way of non-limiting example as a Web page 10, such as a log-in page for an on-line service. Given by way of non-limiting example, the service may be an Internet service provided at a hotel, an Internet Cafe, on a mobile platform via a service such as Connexion by Boeing, or the like. The Web page 10 has been created in English. A title paragraph 11 requests a user to log onto the service. The Web page 10 includes a name label 12 and a field 14 in which a user enters his or her name. A password label 16 is provided, along with a field 18 in which the user enters a password of his or her choice. A confirmed password label 20 is provided, and the user reenters the password in a field 22. The Web page 10 includes a credit card number label 24 and a field 26 in which the user enters a number of a credit card to pay for the service. An expiration date label 28 is provided, along with a field 30 in which the user enters the expiration date of the user's credit card. A credit card type field 32 is provided, and the user enters in a field 34 the name of the credit card, such as without limitation Visa®, MasterCard®, Discover®, American Express®, or the like. The Web page 10 includes a 3-digit code label 36 and a field 38 in which the user enters a 3-digit security code that is found on a reverse side of some types of credit cards, such as Visa® or MasterCard®. A paragraph 40 includes text that indicates the user agrees to be bound to terms and conditions of a user agreement. After the user has filled in the fields 14, 18, 22, 26, 30, 34, and, if applicable, 38 with appropriate information and has acknowledged the information set forth in a paragraph 40, the user clicks on an enter button 42 to log on to the service.

Referring now to FIG. 1 B, a Web page 100 is a French translation of the Web page 10 (FIG. 1A). As such, labels 112, 116, 120, 124, 128, 132, and 136 in French correspond to the labels 12, 16, 20, 24, 28, 32, and 36 (FIG. 1A) in English. Likewise, the fields 114, 118, 122, 126, 130, 134, and 138 correspond to the fields 14, 18, 22, 26, 30, 34, and 38 (FIG. 1A). The paragraphs 111 and 140 in French are translations of the paragraphs 11 and 40 (FIG. 1A). Finally, a button 142 corresponds to the button 42 (FIG. 1A).

Referring to FIGS. 1A and 1B, the Web pages 10 and 100 are generated as follows. The Web page 10 is generated in the default, native language of the organization. Data that populates the labels 12, 16, 20, 24, 28, 32 and 36 and the paragraphs 11 and 40 are stored in a database (discussed below). The labels and paragraphs that are desired for the Web page 10 are identified. The language for the Web page 10, in this case in English, is identified. The data (in English) that populates the labels 12, 16, 20, 24, 28, 32 and 36 and the paragraphs 11 and 40 are pulled from the database into the Web page 10. The Web page 110 is generated in French by referencing the same labels and paragraphs that are identified for the Web page 10 and then uniquely identifying French as the desired language for the Web page 110. The data (in French) that populates the labels 112, 116, 120, 124, 128, 132, and 136 and the paragraphs 111 and 140 are pulled from the database into the Web page 110.

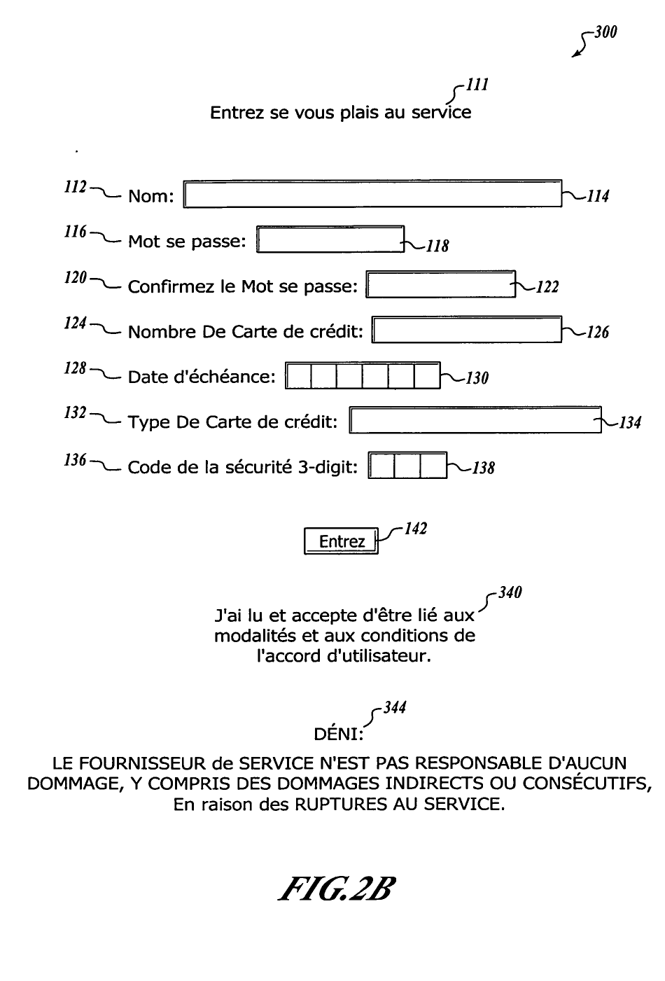

From time to time, it may be desired to revise or add content to the Web page 10. Referring now to FIGS. 1A and 2A, a Web page 200 has been generated by revising some of the content included in the Web page 10 and by adding some content that is not included in the Web page 10. For the sake of brevity, content included in the Web page 200 that is the same as content included in a Web page 10 is shown with like reference numerals and a description thereof is not necessary. It will be noted that the label 36 of the Web page 10 has been revised as a three-digit security code label 236 in the Web page 200. Further, text content of the paragraph 40 of the Web page 10 has been revised and provided as a paragraph 240 in the Web page 200. Finally, an additional paragraph 244 has been added to the Web page 200. The paragraph 244 is not included in the Web page 10.

Now that the Web page 10 has been revised as the Web page 200, it is desired to provide a translation of the Web page 200 to a customer in the customer's native language. In the non-limiting example illustrated herein, it is desired to provide the Web page 200 to a customer in French. Referring now to FIGS. 2A and 2B, a Web page 300 in the French language is generated according to exemplary embodiments of the present invention that will be described below. Advantageously and according to embodiments of the present invention, only the revised or additional content—in this case the label 236 and the paragraphs 240 and 244—is translated into French as a label 336 and paragraphs 340 and 344, respectively. All other paragraphs, labels, and fields in the Web page 300 remain the same as the paragraphs, labels, and fields having the same reference numerals in the Web page 100 (FIG. 1B).

An exemplary method according to an embodiment of the present invention for generating the Web page 300 will now be explained.

Exemplary Method

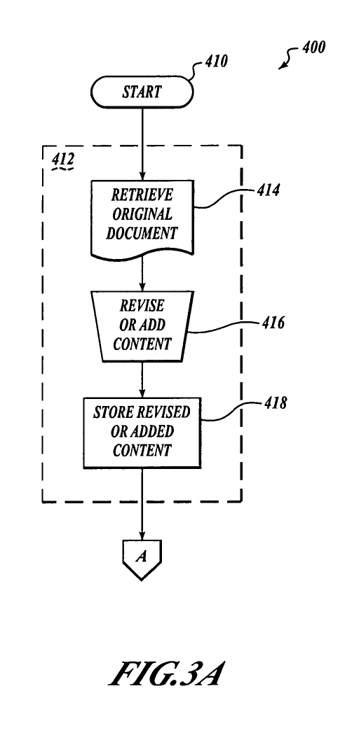

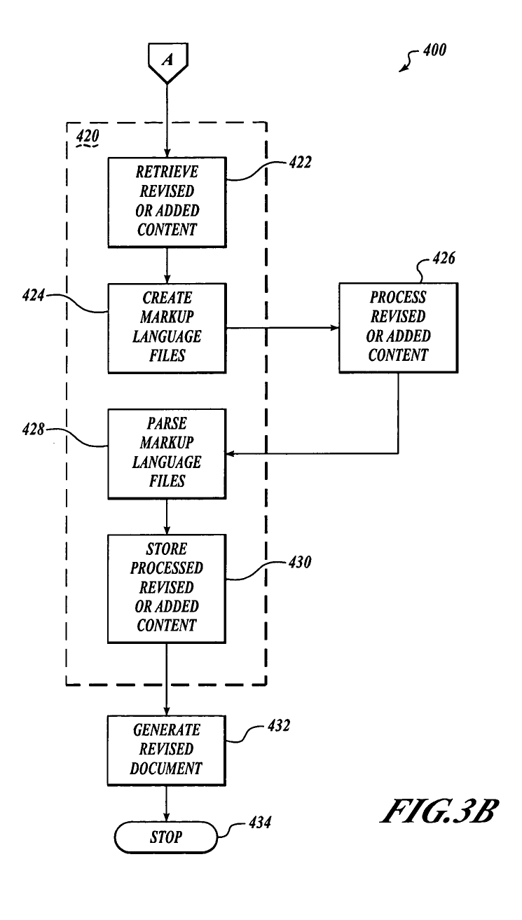

Referring now to FIGS. 3A and 3B, an exemplary method 400 generates the Web page 300 (FIG. 2B). The method 400 begins at a block 410. In a block 412, a user such as a Web page designer, an information analyst, or the like, interfaces with information and systems to revise or add content to the Web page 10 (FIG. 1A). The block 412 includes a block 414 in which the user retrieves an original document, such as the Web page 10 (FIG. 1A), in response to a request from an engineering, maintenance, operations, or other group that identifies a need for document revision; or as part of a scheduled document review; or for any reason whatsoever.

At a block 416 (that is also part of the block 412), the user revises or adds content as instructed or as desired for a particular situation. In the non-limiting example illustrated herein, the label 36 (FIG. 1A) has been revised to the label 236 (FIG. 2A) by inserting the word—security—between “3-digit” and “code”. Further, the paragraph 40 (FIG. 1A) has been revised to the paragraph 240 (FIG. 2A) by inserting the words—have read and—between “I” and “agree”. Finally, the entire paragraph 244 (FIG. 2A) has been added to the Web page 200 (FIG. 2A).

The block 412 also includes a block 418, at which the user stores the revised or added content in a database (discussed below). According to an embodiment of the present invention, the smallest blocks of content that may be stored at a block 418 are labels, titles, images, and paragraphs. In the non-limiting example illustrated herein, the entire label 236 (FIG. 2A) is stored at the block 418—even though only the word “security” has been added to the label 36 (FIG. 1A). Likewise, the entire paragraph 240 (FIG. 2A) is stored at the block 418—even though only the words “have read and” have been added to the paragraph 40 (FIG. 1A). Finally, the entire paragraph 244 (FIG. 2A) is stored at the block 418.

At a block 420, the revised and added content is transformed. The block 420 includes a block 422, at which the revised or added content is retrieved from the database (described below) and is saved in a document in any format as desired for a particular application. In the non-limiting example illustrated herein, the document created at the block 422 includes the content in the label 236 (FIG. 2A), the content in the paragraph 240 (FIG. 2A), and the content in the paragraph 244 (FIG. 2A).

The block 420 also includes a block 424, at which markup language files are created. The markup language files may be created as extensible markup language (XML) files, hypertext markup language (HTML) files, or standard generalized markup language (SGML) files, as desired for a particular application. Because of its flexibility and ease of use, XML is a preferred markup language for use in one embodiment of the present invention. However, it will be appreciated that HTML or SGML may be used as desired for a particular application. Advantageously, embodiments of the present invention have a capability of storing/loading in the database files of various types, such as for example images, HTML, and the like. When the markup language file is created, a “reference” to the file (image, HTML, or the like) is placed in the markup language file and the data stored in the database is extracted to a separate file (image, HTML, or the like). This file (image, HTML, or the like) is then delivered to the translation company or other service provider along with the markup language file. The translation company or other service provider will then see this “reference” in the markup language file and process/translate the file (image, HTML, or the like). The processed/translated data is received in the same format as the delivery.

The markup language files created at the block 424 contain the actual text when text has been loaded in the database. For files that have been loaded into the database as described above, the markup language files contain a reference to the file loaded in the database. As such, the markup language files may describe the revised and/or added content. Further, the markup language files may also describe the document that contains the revised and/or added content. In the non-limiting example illustrated herein, the markup language file is an XML language file that describes the document created at the block 422. The contents of the label 236, the paragraph 240, and the paragraph 244 each make up a respective element that includes an appropriate metatag.

As is known, XML is a standard. As such, XML has a finite definition that is public. Providing content to the translation company or other service provider in XML format advantageously allows a common interface between the organization and the translation company or other service provider. Along with the XML, a document type definition (DTD) tied to the XML suitably is provided to add some additional checks and balances to the XML, thereby enforcing specific rules that apply to the structure of the XML.

At a block 426, the revised or added content is processed. The block 426 may be considered part of the block 420. However, it is not necessary that the block 426 be considered part of the block 420. To that end, the processing performed at the block 426 may be performed by the organization that creates or revises the content to be processed. In this event, processing performed at the block 426 may be considered to be performed within the block 420. However, it will be appreciated that processing performed at the block 426 may be performed outside the organization that creates or revises the content. In this case, processing performed at the block 426 may be considered to fall outside of the block 420.

In the non-limiting example illustrated herein, the processing performed at the block 426 includes translating contents of the label 236 and the paragraphs 240 and 244 (FIG. 2A) from the English language to the French language. As discussed above, the translation performed at the block 426 may be performed by the organization that created or revised the content (in which case the block 426 may be considered part of the block 420). Alternately, the translation performed at the block 426 may be performed by another organization, such as a translation service (in which case the block 426 may be considered to fall outside of the block 420).

The block 420 includes a block 428, at which the markup language files (that now describe the processed revised and added content) are parsed. Parsing the markup language file is the process of reading the markup language file and, depending on a given “tag” in the markup language file, determining actions to be taken. “Tags” indicate to the parsing software what type of data is to be loaded, what the data is or where the software can get the data (in the case of images, HTML, and the like), and where in the database to load the data.

At a block 430 that is part of the block 420, the processed revised or added content is stored in the database. In the non-limiting example illustrated herein, the French content of the label 336 and the paragraphs 340 and 344 (FIG. 2B) is stored in the database at the block 430. It will be appreciated that in one exemplary embodiment the blocks 428 and 430 may be performed at the same time.

When it is desired to generate a document, at a block 432 the content of the document is identified as a first pull criteria and the desired language is identified as a second pull criteria. In the non-limiting example illustrated herein, the Web page 300 (FIG. 2B) is generated by identifying the desired labels, fields, and paragraphs (as described above) and by designating French as the desired language. Using these criteria, the identified content is pulled from the database and populates the Web page 300 (FIG. 2B). The method 400 ends at a block 434.

An exemplary system for performing the method 400 will now be explained.

Exemplary System

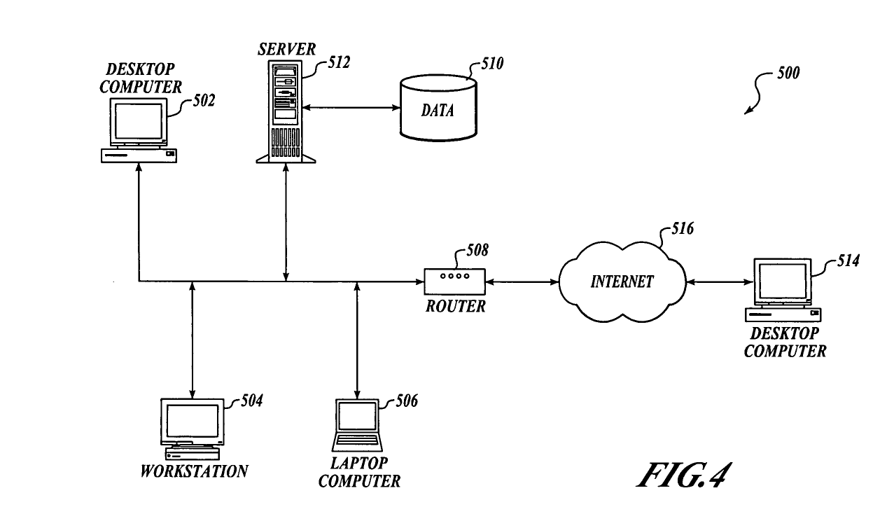

Referring now to FIG. 4, an exemplary system 500 facilitates performing the method 400 (FIGS. 3A and 3B). The system 500 includes any one of a desktop computer 502, a workstation 504, and/or a laptop computer 506. If desired, the computers 502, 504, and 506 may be networked via a router 508. The computers 502, 504, and 506 can access a database 510 via a server 512. As discussed above, the database 510 includes content that is used to generate documents, such as the Web pages 10, 100, 200, and 300.

Data that resides in the database 510 is also processed as described above. In one exemplary embodiment, the data to be processed is retrieved from the database 510 and is transmitted to a computer 514 via a network 516, such as the Internet. In other embodiments, the content to be revised and the revised content are transferred back and forth via portable storage medium, such as a floppy disk, a CD-ROM, or the like, instead of the network 516, if desired for security or other purposes.

The exemplary system 500 illustrated herein is suitable for a large organization that creates and revises its content and transmits the content to be revised outside the organization via the network 516 to a processing organization, such as a translation service. However, it will be appreciated that in other embodiments the system 500 may simply be composed of a single computer that either includes or can access the database 510.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for managing content of a document, the method comprising:
retrieving an original document;
performing at least one of revising and adding content to the original document;
creating first markup language files describing at least one of revised content and added content;
parsing second markup language files describing at least one of revised content and added content that has been processed; and
generating a revised document that includes at least one of processed revised content and processed added content.

2. The method of claim 1, wherein creating the first markup language file includes:
placing a reference to the original document in the first markup language file; and
extracting at least one of the revised content and added content to the first markup language file.

3. The method of claim 1, wherein parsing the second markup language files includes:
reading the second markup language files; and
determining actions to be taken responsive to tags in the second markup language files.

4. The method of claim 1, wherein the markup language includes extensible markup language.

5. The method of claim 1, wherein the markup language includes at least one of hypertext markup language and standard generalized markup language.

6. The method of claim 1, wherein the document includes a Web page.

7. The method of claim 1, further comprising processing the at least one of revised content and added content.

8. The method of claim 7, wherein processing the at least one of revised content and added content includes translating the at least one of revised content and added content contained in the first markup language files from a first language to a second language that is different from the first language.

9. A method for managing content of a web page, the method comprising:
retrieving an original web page;
performing at least one of revising and adding content to the original web page;
creating first extensible markup language files describing at least one of revised content and added content;
parsing second extensible markup language files describing at least one of revised content and added content that has been processed; and
generating a revised web page that includes at least one of processed revised content and processed added content.

10. The method of claim 9, wherein creating the first extensible markup language file includes:
placing a reference to the original document in the first extensible markup language file; and
extracting at least one of the revised content and added content to the first extensible markup language file.

11. The method of claim 9, wherein parsing the second extensible markup language files includes:
reading the second extensible markup language files; and
determining actions to be taken responsive to tags in the second extensible markup language files.

12. The method of claim 9, further comprising processing the at least one of revised content and added content.

13. The method of claim 12, wherein processing the at least one of revised content and added content includes translating the at least one of revised content and added content contained in the first extensible markup language files from a first language to a second language that is different from the first language.

14. A system for managing content of a document, the system comprising:
a user interface configured to retrieve an original document, the user interface being further configured to at least one of revise content and add content to the original document; and
a processor including:
a first component configured to create first markup language files describing at least one of revised content and added content;
a second component configured to parse second markup language files describing at least one of processed revised content and processed added content; and
a third component configured to generate a revised document that includes at least one of the processed revised content and the processed added content.

15. The system of claim 14, wherein the first component is further configured to:
place a reference to the original document in the first markup language file; and
extract at least one of the revised content and added content to the first markup language file.

16. The system of claim 14, wherein the second component is further configured to:
read the second markup language files; and
determine actions to be taken responsive to tags in the second markup language files.

17. The system of claim 14, wherein the markup language includes extensible markup language.

18. The system of claim 14, wherein the markup language includes at least one of hypertext markup language and standard generalized markup language.

19. The system of claim 14, wherein the document includes a Web page.

20. The system of claim 14, further comprising a database configured to store at least one of the original document, the at least one of revised content and added content, and the at least one of processed revised content and processed added content.
